(19) United States
(12) Patent Application Publication
(10) Pub. No.: US 2023/0347717 A1
(43) Pub. Date: Nov. 2, 2023

(54) ELECTRIC VEHICLE, AND CONTROL SYSTEM AND ELECTRIC HEATING DEVICE THEREOF

(71) Applicant: ZHENJIANG HELMHOLTZ THERMAL & TRANSMISSION SYSTEM CO., LTD., Zhenjiang, Jiangsu (CN)

(72) Inventors: Jian SHEN, Zhenjiang, Jiangsu (CN); Shaolin ZHANG, Zhenjiang, Jiangsu (CN); Xianjun MENG, Zhenjiang, Jiangsu (CN); Rong WANG, Zhenjiang, Jiangsu (CN); Xun SUN, Zhenjiang, Jiangsu (CN); Tao CHANG, Zhenjiang, Jiangsu (CN); Yi JIANG, Zhenjiang, Jiangsu (CN)

(21) Appl. No.: 17/997,893

(22) PCT Filed: Aug. 19, 2021
(86) PCT No.: PCT/CN2021/113414

§ 371 Date: Nov. 3, 2022

(30) Foreign Application Priority Data
Feb. 8, 2021 (CN) 202110172895.7

(51) Int. Cl. B60H 1/00; B60H 1/22; H05B 1/02

(52) U.S. Cl. CPC B60H 1/00978; B60H 1/2225; H05B 1/0236; B60H 2001/2265

(57) ABSTRACT

The present application discloses an electric vehicle, and an electric heating device and a control system thereof. The electric heating device includes: n resistance heating units, independently electrically connected in parallel with each other; n switches, electrically connected in series with respective resistance heating units for independently controlling power-on or power-off of the respective resistance heating units; and a controller, configured to selectively turn on or turn off any at least one of the n switches according to a working condition of the electric vehicle, wherein n is a natural number equal to or greater than 2.

### FIELD

The present disclosure relates to the field of an electric heating device for an electric vehicle, and more particularly, to a control system and an electric heating device of an electric vehicle and an electric vehicle including the electric heating device and the control system.

### BACKGROUND

In an electric vehicle (such as a hybrid vehicle or a pure electric vehicle), an electric heating device is generally arranged to achieve temperature control of the environment in the vehicle. The electric heating device is electrically connected with a power battery pack of the electric vehicle, electric energy is converted into heat energy by a heating element in the electric heating device, and then the heat energy is transferred to the environment in the vehicle by a heat dissipation system in the vehicle via a heat conducting medium so as to realize temperature control of the environment in the vehicle, as shown in FIG. 1. In the operation of the electric heating device, over-temperature needs to be prevented so that potential safety hazards are not manifested to the whole vehicle system.

In the conventional solution of the electric heating device, a PTC heater is mostly adopted, but the operating power of the PTC heater cannot be accurately regulated and controlled due to the fact that the impedance of the PTC heater is greatly affected by its temperature. Therefore, a thin film resistance heater has been proposed so far. The power control of the thin film resistance heater is generally performed by PWM continuous control.

However, under some operating conditions, e.g., when the electric vehicle is cold started at a low temperature or at slow charging mode, if the electric heating device is started at this time, it will shock the electrical system of the electric vehicle due to current inrush and/or surge. Consequently the charging system may enter into protection state(s). It may further adversely affected the power battery pack of the electric vehicle, which has already been in an unstable state. Under such circumstances it is difficult to maintain stable operation of the fuel cell stack in cases of fuel cell vehicle applications, as well. Therefore, the conventional thin film resistance heater cannot maintain a stable operation state under all working conditions.

Therefore, how to ensure that the thin film resistance heater can maintain a stable and reliable working state under all working conditions becomes a technical problem to be solved in the field.

### SUMMARY

In view of this, the present application provides an electric heating device of an electric vehicle, and the electric heating device includes: n resistance heating units, independently electrically connected in parallel with each other; n switches, electrically connected in series with respective resistance heating units for independently controlling power-on or power-off of the respective resistance heating units; and a controller, used for selectively turning on or turning off any at least one of the n switches according to a working condition of the electric vehicle, wherein n is a natural number greater than or equal to 2.

Preferably, the resistance values of the n resistance heating units are all the same, or are all different, or are partially the same and partially different.

Preferably, n is 2, and the ratio of the resistance value of one resistance heating unit to the resistance value of the other resistance heating unit in two resistance heating units is 1 to 2.5, preferably 1.5 to 2.5.

Preferably, the electric heating device includes a first main circuit and/or a second main circuit, wherein the first main circuit and the second main circuit are respectively positioned on two sides of the n resistance heating units and are both electrically connected in series with the parallel circuits of the n resistance heating units.

Preferably, the first main circuit is provided with a first main switch; and/or the second main circuit is provided with a second main switch.

Preferably, at least one of the first main circuit, the second main circuit and the parallel circuits is provided with a detection point for intermittent or real-time detection of a voltage value and/or a current value at the detection point. Preferably the detection point is arranged at each of the switches and the main switches.

Preferably, the electric heating device has the following working modes: a single-resistance heating mode in which the controller only turns on one selected switch among the n switches to power on the corresponding resistance heating unit among the n resistance heating units; a full-resistance heating mode in which the controller turns on all of the n switches, thereby powering on all of the n resistance heating units; and a combined-resistance heating mode in which the controller turns on 2 to n−1 of the n switches and does not turn on the other portion of the n switches, thereby powering on a corresponding portion of the n resistance heating units while not powering on the other portion.

Preferably, the controller selects the working mode according to the working condition of the electric vehicle so as to limit the current value or the total current value of the resistance heating unit(s) in the on-state below a predetermined current value under the condition that the electric heating device has predetermined heating power; and/or the controller selects the working mode according to different requirements for heating power under different working conditions, so that the electric heating device has different heating powers without adopting a PWM control mode for the electric heating device.

Preferably, the n switches are all electronic switching tubes, and the controller includes a PWM control module which is independently electrically connected with the n switches respectively.

Preferably, the working frequency of the switches that are turned on under the control of the PWM control module is 1 Hz to 100 KHz, preferably 100 Hz to 1 KHz or 5 kHz to 20 kHz, more preferably 200 Hz to 800 Hz or 7.5 kHz to 15 kHz, further preferably 400 Hz to 600 Hz or 8 kHz to 12 kHz, and most preferably 500 Hz or 10 kHz.

Preferably, the PWM control module has a power error compensation function, wherein, for one switch and one resistance heating unit corresponding thereto, under the condition that the resistance value of the resistance heating unit is within the intermediate interval of an acceptable error range of a standard resistance value, the PWM control module outputs a control signal with a corresponding standard duty ratio at a predetermined power; under the condition that the resistance value of the resistance heating unit is within an upper limit interval of the acceptable error range of the standard resistance value, the PWM control module outputs a control signal with a duty ratio greater than the standard duty ratio to the switch at the predetermined power; and under the condition that the resistance value of the resistance heating unit is within a lower limit interval of the acceptable error range of the standard resistance value, the PWM control module outputs a control signal with a duty ratio smaller than the standard duty ratio to the switch at the predetermined power.

Preferably, the PWM control module has an alternate control mode in which the PWM control module alternately turns on or turns off a plurality of different switches to alternately power on or power off corresponding resistance heating units.

Preferably, the duty ratios of control signals sent by the PWM control module to the switches are adjustable.

According to another aspect of the present application, a control system of an electric vehicle is further provided, and the control system includes: a battery management system, used for monitoring and managing operation of a power battery pack of the electric vehicle; a vehicle-mounted charger, electrically connected with the power battery pack of the electric vehicle; an electric heating device, electrically connected with the power battery pack of the electric vehicle, the electric heating device being the above electric heating device, and the controller being a controller of the electric vehicle and/or a dedicated controller for the electric heating device; and an air conditioning system, used for exchanging heat with the electric heating device through a heat transfer medium for heating the environment in the electric vehicle during working, the heat transfer medium being also used for controlling the temperature of the power battery pack.

Preferably, the electric vehicle has at least one of the following working conditions: a normal warm air working condition, wherein the power battery pack is in a normal working state and provides electric energy to the electric heating device, and the electric heating device converts electric energy into heat energy and supplies the heated heat transfer medium to the air conditioning system; a fast charging working condition, wherein the vehicle-mounted charger is electrically connected with an external charging device, the electric heating device converts electric energy from the power battery pack and/or the vehicle-mounted charger into heat energy and supplies the heated heat transfer medium to the air conditioning system and/or the power battery pack; a low-temperature slow charging working condition, wherein when the temperature of the power battery pack is lower than a lower first temperature threshold value and the vehicle-mounted charger is electrically connected with the external charging device, the vehicle-mounted charger is disconnected from the power battery pack, the electric heating device converts electric energy from the vehicle-mounted charger into heat energy and supplies the heated heat transfer medium to the power battery pack, and until the temperature of the power battery pack is higher than a higher second temperature threshold value, the vehicle-mounted charger is electrically connected with the power battery pack to charge the power battery pack; a normal-temperature slow charging working condition, wherein the electric heating device converts electric energy from the vehicle-mounted charger into heat energy and supplies the heated heat transfer medium to the power battery pack, and the vehicle-mounted charger is electrically connected with the power battery pack to charge the power battery pack; and a low-temperature starting working condition, wherein when the temperature of the power battery pack is lower than a lower third temperature threshold value and the electric vehicle receives a power-on command, the vehicle-mounted charger is disconnected from the power battery pack, the electric heating device is electrically connected with the power battery pack and converts the electric energy of the power battery pack into heat energy and supplies the heated heat transfer medium to the power battery pack, and until the temperature of the power battery pack is higher than a higher fourth temperature threshold value, the electric vehicle enters the normal warm air working condition.

Preferably, the PWM control module of the electric heating device sends a control signal to the selected switch to continuously regulate and control the power of the electric heating device in at least one of the normal warm air working condition, the fast charging working condition and the normal-temperature slow charging working condition.

Preferably, in the low-temperature slow charging working condition, the current value of the electric heating device is maintained stable and is not higher than a predetermined current value I_{predetermined}, and the power of the electric heating device is regulated by regulating an output voltage of the vehicle-mounted charger without adopting a PWM control mode; and/or in the low-temperature starting working condition, the current value of the electric heating device is maintained stable and is not higher than the predetermined current value I_{predetermined}, and the power of the electric heating device is regulated by regulating the output voltage of the power battery pack without adopting the PWM control mode.

Preferably, the controller includes: a voltage detection module, configured to detect the output voltage of the vehicle-mounted charger and/or the power battery pack; a voltage regulation module, configured to regulate the output voltage of the vehicle-mounted charger and/or the power battery pack; and a judging module, configured to obtain a calculated current value I_{calculated} of the electric heating device according to the ratio of the output voltage of the vehicle-mounted charger and/or the power battery pack to the resistance value of the selected resistance heating unit and to compare the calculated current value I_{calculated} with the predetermined current value I_{predetermined}, wherein, under the condition that the calculated current value I_{calculated} is greater than or equal to the predetermined current value I_{predetermined}, the controller lowers the output voltage of the vehicle-mounted charger and/or the power battery pack until the calculated current value I_{calculated} is not greater than the predetermined current value I_{predetermined}; and under the condition that the calculated current value I_{calculated} is smaller than the predetermined current value I_{predetermined}, the resistance heating unit is powered on.

Preferably, the electric heating device includes a first resistance heating unit having a greater resistance value and a second resistance heating unit having a smaller resistance value, and the judging module obtains corresponding I_{calculated 1} and I_{calculated 2} for the two resistance heating units respectively, wherein, under the condition that I_{calculated 1} is greater than I_{predetermined}, the controller lowers the output voltage of the vehicle-mounted charger and/or the power battery pack; under the condition that I_{calculated 2} is greater than I_{predetermined} and I_{calculated 1} is smaller than I_{predetermined}, the controller turns on the first resistance heating unit and turns off the second resistance heating unit; and under the condition that I_{calculated 2} is smaller than I_{predetermined}, the controller turns on the first resistance heating unit and turns off the second resistance heating unit; or the controller turns on the second resistance heating unit and turns off the first resistance heating unit; or the controller alternately turns on the first resistance heating unit and the second resistance heating unit; or the controller raises the output voltage of the vehicle-mounted charger and/or the power battery pack to a range that satisfy “I_{calculated 2} is greater than I_{predetermined} and I_{calculated 1} is smaller than I_{predetermined}” and then turns on the first resistance heating unit and turns off the second resistance heating unit.

In addition, the present application further provides another control system of an electric vehicle, and the control system includes: a battery management system, configured to monitor and manage operation of a first power battery pack and a second power battery pack of the electric vehicle, the first power battery pack being a fuel cell stack or a rechargeable battery pack, and the second power battery pack being a rechargeable battery and electrically connected with the first power battery pack; an electric heating device, electrically connected with the first power battery pack and the second power battery pack of the electric vehicle; and an air conditioning system, configured to exchange heat with the electric heating device through a heat transfer medium for heating the environment in the electric vehicle during working, the heat transfer medium being also used for controlling the temperature of the first power battery pack and/or the second power battery pack, wherein the electric heating device is the electric heating device provided by the present application, and the controller is a controller of the electric vehicle and/or a dedicated controller for the electric heating device.

Preferably, the electric vehicle has at least one of the following working conditions: a normal warm air working condition, wherein the power battery pack is in a normal working state and provides electric energy to the electric heating device that converts the electric energy into heat energy and supplies the heated heat transfer medium to the air conditioning system; and a low-temperature starting working condition, wherein when the temperature of the power battery pack is lower than a lower fifth temperature threshold value and the electric vehicle receives a power-on command, the electric heating device receives electric energy from the first power battery pack and/or the second power battery pack and converts the electric energy into heat energy so as to supply the heated heat transfer medium to the first power battery pack and/or the second power battery pack, and until the temperature of the first power battery pack and/or the second power battery pack is higher than a higher sixth temperature threshold value, the electric vehicle enters the normal warm air working condition.

Preferably, in the low-temperature starting working condition, the power of the electric heating device is responsive to the power of the first power battery pack and/or the second power battery pack that supplies power to the electric heating device, and is positively correlated with the output voltage of the first power battery pack and/or the second power battery pack that supplies power to the electric heating device without adopting the PWM control mode.

In addition, the present application further provides an electric vehicle, wherein the electric vehicle includes the above control system, and the electric vehicle is a pure or battery electric vehicle, a fuel cell vehicle or a hybrid electric vehicle.

According to the technical solution of the present application, the n resistance heating units are electrically connected with each other in parallel independently and the n switches are used to independently control the resistance heating units respectively, so that the electric heating device can realize multiple working methods so as to be applicable to specific working conditions under all working conditions to maintain a reliable and stable working state.

Other features and advantages of the present application will be described in detail in the following part of Detailed Description of the Embodiments.

### BRIEF DESCRIPTION OF THE DRAWINGS

The accompanying drawings, which constitute a part of the present application, serve to further illustrate the present application. Exemplary embodiments of the present application and descriptions thereof serve to explain the present application. In the drawings,

FIG. 1 is a schematic view of a circuit structure of resistance heating units in an electric heating device according to a preferred embodiment of the present application;

FIGS. 2 to 4 are schematic diagrams of circuit structures of resistance heating units in an electric heating device according to different preferred embodiments of the present application;

FIG. 5 is a schematic diagram showing the power, current and voltage of an electric heating device;

FIG. 6 is a schematic diagram illustrating different duty ratios of control signals output by a PWM control module in a power error compensation function;

FIGS. 7A and 7B are schematic diagrams illustrating working states of switches and current changes in an alternate control mode;

FIG. 8 is a schematic diagram of principles of a control system of an electric vehicle according to a preferred embodiment of the present application;

FIG. 9 is a schematic diagram of the electric connection relationship between a vehicle-mounted charger and an electric heating device under a low-temperature slow charging working condition;

FIGS. 10 and 11 are schematic views illustrating working of the electric heating device shown in FIG. 9 in different sectional control modes;

FIG. 12 is a schematic flow chart illustrating the current limiting control on a vehicle-mounted charger and an electric heating device performed by a controller under a low-temperature slow charging working condition;

FIG. 13 is a schematic diagram of another control system of the electric vehicle according to the present application.

### DETAILED DESCRIPTION OF THE EMBODIMENTS

The technical solutions of the present application will be described in detail below with reference to the accompanying drawings in conjunction with embodiments.

In an electric vehicle, due to lack or absence of residual heat of an engine, an electric heating device is generally arranged to exchange heat with an air conditioning system of the vehicle, thereby achieving temperature management of the environment in the vehicle. The electric heating device may be a PTC electric heating device, but preferably a thin film resistor serves as an electric heating device of a resistance heating unit.

In the process of using the electric vehicle, the electric vehicle has a plurality of different working conditions, and under different working conditions, the power transmission relationship between the power battery (pack) of the electric vehicle and various electric devices also faces different requirements. For example, when the electric vehicle is started, whether the power battery is in a good working state has a direct influence on the power control of other electric devices. For the electric heating device provided by the present application, the electric heating device is also an important electric device in the electric vehicle, and thus corresponding management and control on the working condition of the electric heating device under different working conditions of the electric vehicles are required to be investigated, so that the whole system is in a safe and stable operating state. Therefore, firstly, an improved solution of the electric heating device according to the embodiments of the present application, particularly, an improved design of the resistance heating unit will be explained hereinbelow; then an explanation is given of how the operational relationship between the electric vehicle and electric equipment including the electric heating device provided in the present application is matched in the electric vehicle of the electric heating device provided by the present application.

1. Electric Heating Device of Electric Vehicle

1.1 Circuit Structure of Electric Heating Device

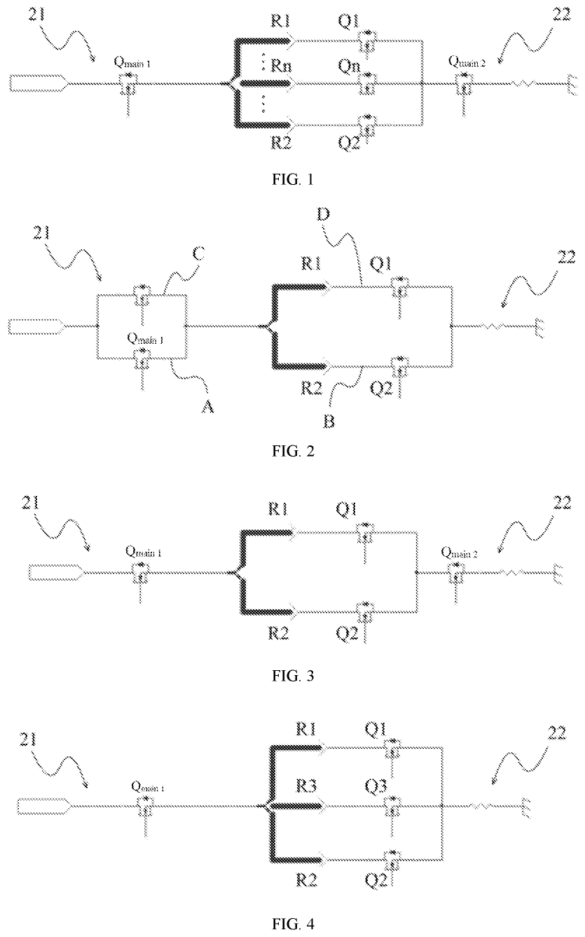

As shown in FIGS. 1 to 4, an electric heating device according to the present application includes: n resistance heating units R1, R2, . . . , Rn, independently electrically connected in parallel with each other; n switches Q1, Q2, . . . , Qn, electrically connected in series with respective resistance heating units for independently controlling power-on or power-off of the respective resistance heating units; and a controller selectively turning on or turning off any at least one of the n switches according to the working condition of the electric vehicle, wherein n is a natural number equal to or greater than 2.

As described above, in the technical solution of the present application, a thin film resistor is used as a resistance heating unit. Traditionally, an electric heating device includes a single resistance heating unit, resulting in a resistance value that is not variable, and therefore power regulation is mostly achieved by current and/or voltage regulation in order to accommodate different power requirements under different working conditions. Especially under some working conditions that current is limited, if the resistance of the resistance heating unit is fixed, in order to enable the current flowing through the resistance heating unit to meet the current limiting requirement, the power of the electric heating device must be lowered, so that the electric heating device cannot work at a higher power, and the electric vehicle is thereby further influenced and cannot realize regulation and control of the ambient temperature as soon as possible.

In the technical solution of the present application, the n resistance heating units R1, R2, . . . and Rn are independently electrically connected in parallel with each other, and the n switches Q1, Q2, . . . and Qn are used for independently controlling the resistance heating units, so that the working resistance value of the electric heating device is adjustable according to working states of different resistance heating units. Thus the electric heating device can realize multiple working modes to adapt to various working conditions of the electric vehicle, so as to maintain a stable and reliable working state. In other words, compared with the traditional mode, variability is designed for the parameter of the heating resistance value of the electric heating device, so that the electric heating device is suitable for various working conditions.

The resistance values of the n resistance heating units R1, R2, . . . and Rn are all the same, are all different, or are partially the same and partially different. This may be designed and selected according to different application. In addition, the resistance value of each of the resistance heating units R1, R2, . . . and Rn may be designed and selected according to specific application. Preferably, as shown in FIGS. 2 and 3, n is 2. That is, there are two resistance heating units connected in parallel in the electric heating device. Or, as shown in FIG. 4, n is 3, there are three resistance heating units connected in parallel in the electric heating device. Of course, the present application is not limited to the above-described embodiments, and n may be a natural number greater than or equal to 2 as shown in FIG. 1. The specific number of the resistance heating units may be specifically selected and designed according to factors such as processing costs, difficulties in production and manufacture and application working conditions.

According to a preferred embodiment of the present application, in two resistance heating units, the ratio of the resistance value of one resistance heating unit to the resistance value of the other resistance heating unit is 1 to 2.5, preferably 1.5 to 2.5, and most preferably 2. Therefore, when one resistance heating unit is selected to be turned on, resistance values of different magnitudes can be obtained. This naturally applies to other embodiments as well.

The n switches Q1, Q2, . . . , Qn are used to control the resistance heating units independently, so that the electric heating device provided by the present application has the following working modes:
a single-resistance heating mode in which the controller only turns on one selected switch among the n switches to power on the corresponding resistance heating unit among the n resistance heating units;
a full-resistance heating mode in which the controller turns on all of the n switches to power on all of the n resistance heating units; and
a combined-resistance heating mode in which the controller turns on 2 to n−1 of the n switches and turns off the other portion of the n switches to power on a corresponding portion of the n resistance heating units while powering off the other portion.

Obviously, by means of the technical solution of the present application, the working resistance value of the electric heating device can be made to have multiple selection possibilities so as to adapt to various different application working conditions.

Preferably, as shown in FIGS. 1 to 4, the electric heating device according to the present application includes a first main circuit 21 and/or a second main circuit 22, wherein the first main circuit 21 and the second main circuit 22 are respectively located at two sides of the n resistance heating units and are electrically connected in series with the parallel circuits of the n resistance heating units, and the first main circuit 21 is provided with a first main switch Q_{main 1} and/or the second main circuit 22 is provided with a second main switch Q_{main 2}. By arranging the first main switch Q_{main 1} and/or the second main switch Q_{main 2}, the power-on state of the resistance heating units can be controlled in a centralized manner to improve the integral safety of the electric heating device. Preferably, there may be a plurality of first main switches and second main switches arranged in parallel (as shown in FIG. 2), thereby further improving the system safety margin.

For example, as shown in FIG. 2, the power-on and power-off of the main circuit is controlled by turning on and turning off the first main switch Q_{main 1}. With the main circuit being powered on, if both the switches Q1 and Q2 are turned on (on), simultaneous heating by two circuits is achieved; if the switch Q1 is turned on (on) and Q2 is turned off (off), only the resistance heating unit R1 is powered on and performs heating working, but R2 does not work; and if the switch Q2 is turned on (on) and Q1 is turned off (off), the resistance heating unit R2 is powered on and performs heating working, but R1 does not work. Therefore, three different combination modes of resistance can be realized according to the specific embodiment, and then three different working modes are realized. Similarly, in the preferred embodiment shown in FIG. 4, seven different combinations of resistance can be realized, and thus seven different working modes can be realized.

Preferably, as shown in FIG. 2, at least one of the first main circuit 21, the second main circuit 22 and the parallel circuits is provided with a detection point for intermittent or real-time detection of a voltage value and/or a current value at the detection point. Usually, the detection points A, B, C, D are disposed at each of the switches Q1, Q2, . . . , Qn and the main switches.

By arranging the detection points, the current and/or voltage value at each detection point can be detected so as to judge the working state of the corresponding switch or the whole system. For example, as shown in FIG. 2, detection points are arranged at two first main switches Q_{main 1} and the two switches Q1 and Q2, and when these switches are turned on and in the on-state, corresponding reasonable voltage and/or current values should be detected at the corresponding detection points. If no reasonable voltage and/or current values are detected, the corresponding switches can be judged to be defective. When these switches are turned off and in the off state, normally, corresponding reasonable voltage values and/or current values should be detected at the corresponding detection point positions, and if no reasonable voltage values and/or current values are detected, the corresponding switches can be judged to be defective. The voltage value and/or current value can be detected with a conventional method, e.g., the voltage value at the detection point can be detected with a voltage division method or an operational amplification method. Parameters detected at the detection point may be sent to the controller, and then the controller determines and processes the parameters so as to take corresponding measures. For example, if it is determined that a certain switch Q has a fault, the corresponding parallel circuit can be disconnected so that it no longer participates in working.

The circuit structure of the resistance heating unit of the electric heating device according to the present application has been described in detail above. The mode of controlling the above-described electric heating device will be described in detail below.

1.2 Control Solution of Electric Heating Device

As described above, the electric heating device has a plurality of working modes based on the circuit structure of the resistance heating unit of the electric heating device. Therefore, during working, the controller can select the working mode according to the working condition of the electric vehicle to limit the current value or the total current value of the resistance heating unit(s) in the on-state below a predetermined current value under the condition that the electric heating device has a predetermined heating power.

For the electric heating device, as shown in FIG. 5, the relationship between its power P, and the voltage U, current I and resistance r thereof is: P=U*I=U²/r=I²*r. In the case of constant heating power, the higher the voltage, the higher the drive current of the electric heating device due to the constant resistance value. The higher drive current may affect negatively the system safety. By using the technical solution of the present application, the resistance value of the resistance heating unit of the electric heating device has a selectable margin range, so that on the premise of ensuring constant heating power, a relatively great resistance value can be selected, so that the drive current of the electric heating device is limited, and the safety of the system is ensured.

As another alternative working mode, the controller selects the working mode of the electric heating device according to different requirements for the heating power under different working conditions of the electric vehicle, so that the electric heating device has different heating powers without adopting the PWM control mode for the electric heating device.

Preferably, for the resistance heating unit in the form of a thin film resistor, the n switches are all electronic switching tubes, and the controller includes a PWM control module that is electrically connected with the n switches independently. Since the duty ratio of the control signal sent by the PWM control module to each of the switches is adjustable, the power regulation of each of the resistance heating units is realized only by adjusting the duty ratio of PWM control signals. However, the present application is not limited thereto. For example, the switch may be other types of electrical control elements, the controller may be a vehicle-mounted controller such as an ECU, a BMS, an air conditioner controller, or may be a separate controller of the electric heating device, such as a single chip microcomputer or an integrated chip. Preferably, the switches Q1, Q2, . . . and Qn are dedicated switches (serving only to control the on/off of the corresponding resistance heating units) for the corresponding resistance heating units R1, R2, . . . and Rn, and the resistance heating units R1, R2, . . . and Rn are only connected in parallel. This arrangement enables the circuit structure of the electric heating device to be simpler, thereby facilitating production and manufacturing while reducing the failure rate of the system and improving safety redundancy.

Traditionally, the PWM continuous power control mode is mostly adopted for the resistance heating unit in the form of a thin film resistor, and has the advantage that the power of the electric heating device can be precisely controlled and regulated by the precise adjustment of the duty ratio. However, under some conditions, e.g., when the electric vehicle is slowly charged at a low temperature, the drive current is greatly limited, and thus the power of the electric heating device can only be limited to a relatively low level, and the regulation of the ambient temperature of the electric vehicle cannot be realized as quickly as possible. In the technical solution of the present application, because the resistance of the resistance heating unit has flexible choice, consequently on the premise of adopting the PWM control mode in the normal working condition, there is no need to adopt the PWM control mode for some working conditions that drive current is limited, but different resistance values are selected to realize different working powers without breaking through an upper limit of the drive current. Therefore, in this working mode, working can be carried out at a relatively high power in order to achieve quick regulation of the ambient temperature of the electric vehicle. In addition, the temperature of the power battery can be regulated in addition to the regulation of the ambient temperature of the electric vehicle.

Therefore, according to the technical solution of the present application, the control mode of the electric heating device can be selected according to the working condition of the electric vehicle, and a non-PWM control mode is selected in certain working conditions with the limitation requirement on the drive current, so that the electric heating device can work at a relatively high power. Meanwhile, in the normal working condition, the working power of the electric heating device can be accurately controlled and regulated according to a traditional PWM control mode.

In the traditional PWM control mode, interference with other electrical parts is likely to occur, and oscillation is caused, so that normal work of other related electrical parts is influenced. The reason for this is that the higher the frequency, the smaller the current ripple, but the higher the loss of the power supply. Therefore, in the preferred embodiment of the present application, it is necessary to adjust the frequency of the PWM control signal described above so as to lower the frequency of the PWM control signal sent to each of the switches in the condition that the current ripple requirement is satisfied. Therefore, the controller can output PWM control signals of different frequencies according to the requirements of the application working conditions of the electric heating device, so that the frequency of the PWM control signals is changed to maintain small-amplitude oscillation of the controller, and the electric oscillation of the related electric parts can be reduced while the power loss of the heater is reduced. Preferably, the working frequency of the switches that are turned on under the control of the PWM control module is 1 Hz to 100 KHz, preferably 100 Hz to 1 KHz or 5 kHz to 20 kHz, more preferably 200 Hz to 800 Hz or 7.5 kHz to 15 kHz, further preferably 400 Hz to 600 Hz or 8 kHz to 12 kHz, and most preferably 500 Hz or 10 kHz.

In addition, the resistance value of the resistance heating unit is theoretically accurate, but due to the deviation in production and manufacturing, an error in the resistance value of the resistance heating unit is inevitably caused. In practical application, a resistance heating unit with the resistance value error within the allowable range can be regarded as a qualified product, and a resistance heating unit with the resistance value error beyond the acceptable error range can be regarded as a rejected product. However, the resistance value error of the resistance heating unit may directly influence the working power of the electric heating device and lead to a power error. Over time, this power error may directly influence the working of the electric heating device. In order to solve the problem of the power error, the power of the resistance heating unit is preferably compensated by adjusting the duty ratio of the PWM control signal.

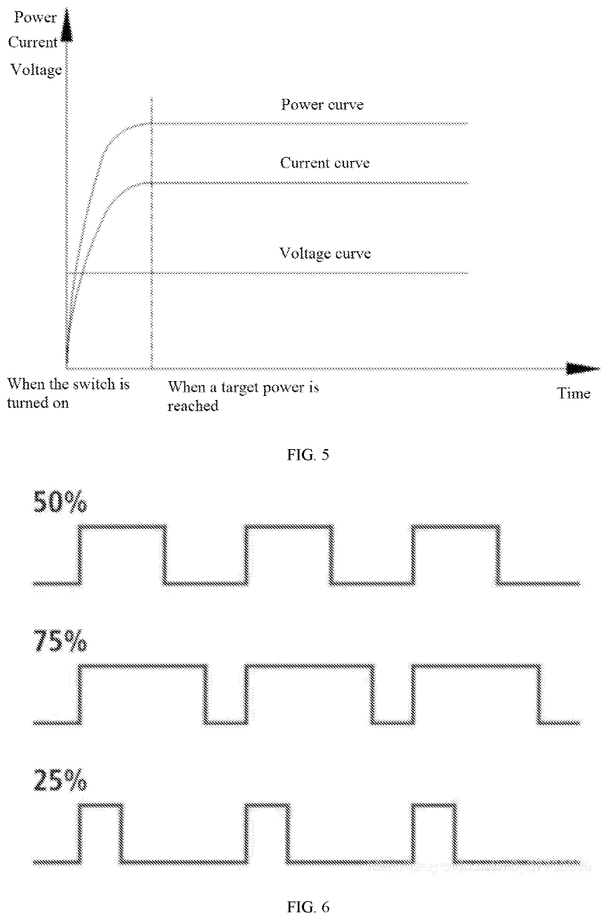

Specifically, preferably, the PWM control module has a power error compensation function, wherein, for one switch and the resistance heating unit corresponding thereto, if the resistance value of the resistance heating unit is within an intermediate interval of an acceptable error range of a standard resistance value, the PWM control module outputs a control signal with a corresponding standard duty ratio to the switch at a predetermined power, e.g., a PWM control signal with a duty ratio of 50% as shown in FIG. 6.

If the resistance value of the resistance heating unit is within an upper limit interval of the acceptable error range of the standard resistance value (namely the actual resistance value is greater than the standard resistance value), the PWM control module outputs a control signal with a duty ratio greater than the standard duty ratio at the predetermined power to the switch, e.g., a PWM control signal with a duty ratio of 75% as shown in FIG. 6.

If the resistance value of the resistance heating unit is within a lower limit interval of the acceptable error range of the standard resistance value (namely the actual resistance value is smaller than the standard resistance value), the PWM control module outputs a control signal with a duty ratio smaller than the standard duty ratio at the predetermined power to the switch, e.g., a PWM control signal with a duty ratio of 25% as shown in FIG. 6.

The drive current (and the corresponding working power) of the electric heating device has a certain relation with the duty ratio of the PWM control signal, and the larger the duty ratio, the longer the working output time of the PWM control signal, and the longer the on time of the corresponding switch, such as Q3 and Q4, and therefore, the larger the drive current of the electric heating device, and the larger the working power. Conversely, the smaller the duty ratio of the PWM control signal, the smaller the drive current (and the corresponding working power) of the electric heating device. Therefore, by adjusting the duty ratio of the PWM control signal, the working power of the controlled resistance heating unit can be regulated, and thus the whole working power of the electric heating device can be regulated. The power error of the resistance heating unit can also be compensated as described above. It should be noted that the examples of the duty ratios of the PWM control signals recited in the present application (e.g. 25%, 50%, 75%, etc.) are all exemplary and cannot be construed as limiting the present application, and those skilled in the art can select different duty ratios according to the actual working conditions. For example, the duty ratio of the PWM control signal can be regulated and controlled in a range of 0-100% with 1%-5% as a regulating unit.

Preferably, based on the technical solution of the present application, the PWM control module has an alternate control mode in which the PWM control module alternately turns on or turns off a plurality of different switches to alternately power on or power off the corresponding resistance heating units.

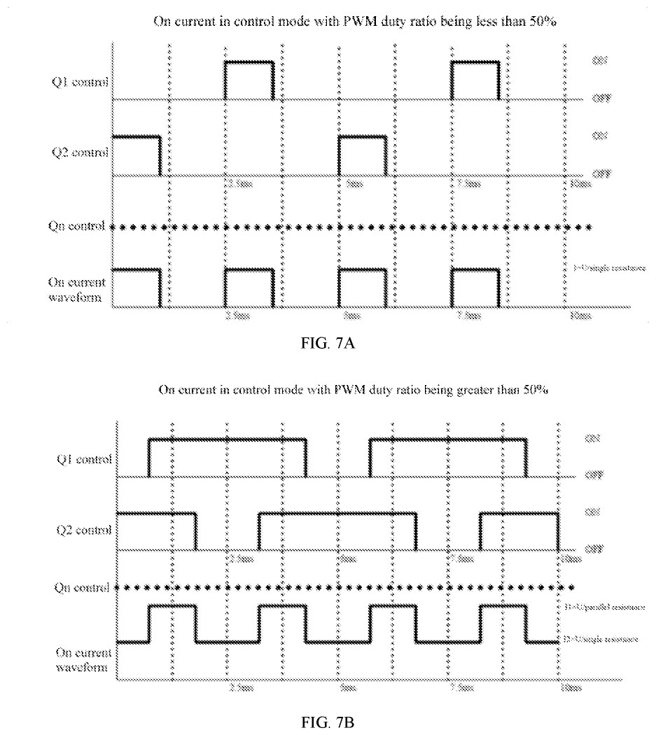

FIGS. 7A and 7B are schematic diagrams exemplarily showing the working of the resistance heating unit under PWM alternate control based on FIG. 3, in which an abscissa is a time series when the switch is turned on in milliseconds ms. As shown in FIG. 7A, the PWM control module sends control signals to the switches Q1 and Q2 respectively (the dashed line of Qn indicates that the embodiment of FIG. 1 is also applicable, and the duty ratio of the PWM control signal of the switch Qn can be selected according to specific working conditions) to make different switches be turned on or turned off alternately. Specifically, the duty ratio of the PWM control signal may be less than 50%, then Q2 is turned off while Q1 is turned on, Q1 is turned off while Q2 is turned on, and Q1 and Q2 are in a state of alternate on and off. It should be noted that the controller can adjust the duty ratio of the PWM control signal according to the heating power of the electric heating device, so as to regulate the drive current and the working power of the electric heating device. For example, as shown in FIG. 7B, the duty ratio of the PWM control signal may be greater than 50%, then Q1 and Q2 are alternately turned on or turned off, and have independent and/or overlapping simultaneous working intervals. In this case, a current waveform (superimposed waveform) I1 represents the current value when two resistance heating units work in parallel, and a current waveform I2 represents a current value when a single resistance heating unit works alone. It should be noted that the above explanation in connection with FIGS. 7A and 7B is exemplary and cannot be construed as limiting the present application. For example, the PWM control signal may have other duty ratios to adapt to different application working conditions.

Therefore, according to the preferred embodiment, by adjusting the duty ratio of the PWM control signal and/or the mode of PWM control switching of heating parts of the plurality of resistance heating units, the drive current of the electric heating device during the on period of the switch controlled by the PWM control signal can be reduced, thereby reducing the adverse effect of disturbance of the load current formed by the switch controlled by the PWM signal on the stable operation of other electric parts (e.g., the power battery).

Various preferred control modes of the electric heating device have been described in detail above. The application solution of the electric heating device in an electric vehicle system will be described in detail.

2. Control System of Electric Vehicle

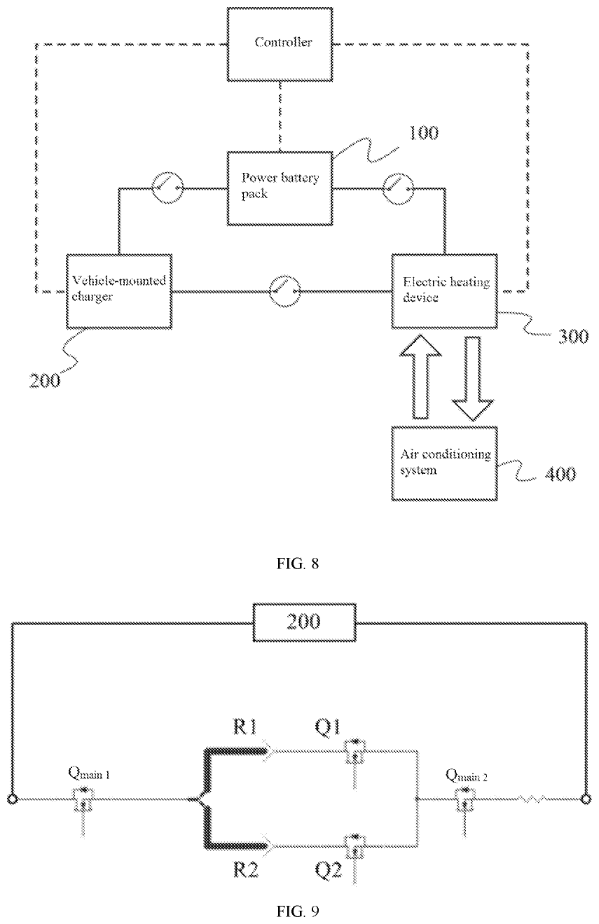

As shown in FIG. 8, the control system of an electric vehicle includes: a battery management system, used for monitoring and managing the operation of a power battery pack 100 of the electric vehicle; a vehicle-mounted charger 200, electrically connected with the power battery pack 100 of the electric vehicle; an electric heating device 300, electrically connected with the power battery pack 100 of the electric vehicle, wherein the electric heating device is the above electric heating device provided by the present application, and the controller is a controller of the electric vehicle and/or a dedicated controller for the electric heating device; and an air conditioning system 400, used for exchanging heat with the electric heating device 300 through a heat transfer medium for heating the environment in the electric vehicle during working, wherein the heat transfer medium is also used for controlling the temperature of the power battery pack 100.

As described above, based on the above technical solution of the electric heating device provided in the present application, under various working conditions of the electric vehicle, the PWM control mode can be adopted in a normal working state to accurately regulate the working power of the electric heating device, or different powers at different resistance values may be selected for some working conditions in which the drive current is limited without adopting the PWM control mode.

The electric vehicle has at least one of the following working conditions:
a normal warm air working condition, wherein the power battery pack is in a normal working state and provides electric energy to the electric heating device 300 that converts the electric energy into heat energy and supplies the heated heat transfer medium to the air conditioning system so as to allow the air conditioning system to supply warm air to the electric vehicle;
a fast charging working condition, wherein the vehicle-mounted charger 200 is electrically connected with an external charging device (i.e., a charging gun), and the electric heating device converts electric energy from the power battery pack and/or the vehicle-mounted charger 200 into heat energy and supplies the heated heat transfer medium to the air conditioning system and/or power battery pack so as to allow the air conditioning system to supply warm air to the electric vehicle, and/or supplies heat to the power battery pack so as to enable the power battery pack to be in a good working state;
a low-temperature slow charging working condition, wherein when the temperature of the power battery pack is lower than a lower first temperature threshold value (the first temperature threshold value is, e.g., −40° C. to 0° C.) and the vehicle-mounted charger 200 is electrically connected with an external charging device, the vehicle-mounted charger 200 is disconnected from the power battery pack, the electric heating device converts electric energy from the vehicle-mounted charger 200 into heat energy and supplies the heated heat transfer medium to the power battery pack, and until the temperature of the power battery pack is higher than a higher second temperature threshold value (the second temperature threshold value is, e.g., −10° C. to 5° C.), the vehicle-mounted charger 200 is electrically connected with the power battery pack to charge the power battery pack;
a normal-temperature slow charging working condition, wherein the electric heating device converts electric energy from the vehicle-mounted charger 200 into heat energy and supplies the heated heat transfer medium to the power battery pack, and the vehicle-mounted charger 200 is electrically connected with the power battery pack to charge the power battery pack; and
a low-temperature starting working condition, wherein when the temperature of the power battery pack is lower than a lower third temperature threshold value (the third temperature threshold value is, e.g., −40° C. to −10° C.) and the electric vehicle receives a power-on command, the vehicle-mounted charger 200 is disconnected from the power battery pack, the electric heating device is electrically connected with the power battery pack and used for converting electric energy of the power battery pack into heat energy and supplying the heated heat transfer medium to the power battery pack, and until the temperature of the power battery pack is higher than a higher fourth temperature threshold value (the fourth temperature threshold value is, e.g., −20° C. to 5° C.), the electric vehicle enters the normal warm air working condition.

The above working conditions of the electric vehicle are divided based on the matching relationship between the electric heating device and the related electrical devices, do not limit the present application, nor exclude that the working conditions of the electric vehicle are divided into other various working conditions based on other criteria. The working conditions of the electric vehicle listed in the present application can be roughly divided into the working condition having limitation on drive current of the electric heating device (e.g., the low-temperature slow charging working mode and the low-temperature starting working mode) and the working condition having no limitation on the drive current of the electric heating device (e.g., the normal warm air working condition, the fast charging working condition, the normal-temperature slow charging working condition and the like). This is because the temperature has a direct influence on the working condition of the power battery pack of the electric vehicle. If the battery temperature is too high or too low the functional and safe operations of the power battery will be influenced, which will eventually lead to serious defects such as thermal runaway and severe battery capacity decay.

Therefore, for the working condition having no limitation on the drive current, e.g., at least one of the normal warm air working condition, the fast charging working condition and the normal-temperature slow charging working condition, the PWM control mode can be adopted to perform PWM control on the switches Q1, . . . and Qn. That is, the PWM control module of the electric heating device sends out a control signal to the selected switch to continuously regulate and control the power of the electric heating device, as shown in FIGS. 7A and 7B.

For the working condition having limitation on the drive current, e.g., the low-temperature slow charging working condition and/or the low-temperature starting working condition, the PWM control mode is not adopted. Specifically, under the low-temperature slow charging working condition, the current value of the electric heating device is maintained stable and is not higher than a predetermined current value I_{predetermined}. The regulation of the power of the electric heating device is realized by regulating the output voltage of the vehicle-mounted charger 200 without adopting the PWM control mode. In the low-temperature starting working condition, the current value of the electric heating device is maintained stable and is not higher than the predetermined current value I_{predetermined}, the power of the electric heating device is regulated by regulating the output voltage of the power battery pack without adopting the PWM control mode.

For example, as shown in FIG. 9, under the low-temperature slow charging working condition, when the controller learns that the temperature of the power battery pack is lower than the lower first temperature threshold value, and that the vehicle-mounted charger 200 is electrically connected with an external charging device (e.g., a charging gun), the vehicle-mounted charger 200 is disconnected from the power battery pack, and the electric heating device is electrically connected with the vehicle-mounted charger 200, so that the electric energy from the vehicle-mounted charger 200 is converted into heat energy by the resistance heating units R1 and R2 and the heated heat transfer medium is supplied to the power battery pack until the temperature of the power battery pack is higher than the higher second temperature threshold value (the second temperature threshold value is, e.g., −10° C. to 5° C.), so that the healthy state of the power battery pack is restored to a normal state. Then the vehicle-mounted charger 200 is electrically connected with the power battery pack again to charge the power battery pack.

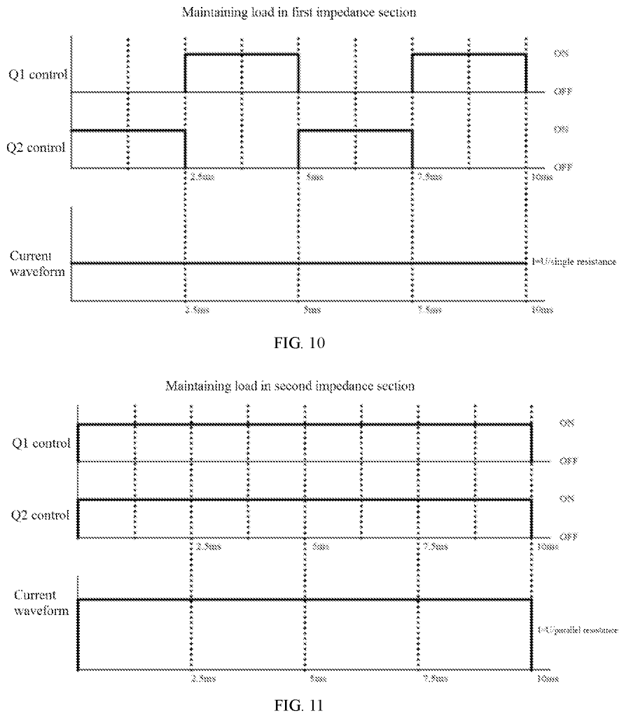

Under the low-temperature slow charging working condition, as shown in FIGS. 9, 10 and 11, the electric heating device according to the present application does not adopt the PWM control mode, but adopts a sectional control method. Specifically, the load resistor of the electric heating device can be maintained to be stable in a first impedance section (a single resistor performs heating working, wherein the switches Q1 and Q2 are alternately turned on or off, or only Q1 or Q2 can be selectively turned on) or a second impedance section (two parallel resistors perform the heating working simultaneously, and the switches Q1 and Q2 are turned on simultaneously), and under the condition that the output voltage of a vehicle-mounted charger (namely the voltage loaded to a resistance heating unit of the electric heating device) is not changed, since the overall resistor impedance of the electric heating device is maintained stable and unchanged, the drive current of the electric heating device is maintained stable. When the working power of the electric heating device needs to be regulated, the controller (e.g., a vehicle controller or an air conditioner controller) may send a voltage instruction and a current limiting instruction to the vehicle-mounted charger, the vehicle-mounted charger regulates the output voltage in a drive current limiting mode to further regulate the heating power of the electric heating device. Although FIGS. 9-11 and the depictions above are described with respect to the low-temperature slow charging working condition, it will be understood by those skilled in the art that the same may also similarly apply to the low-temperature starting working condition.

By means of the above solution, especially by maintaining the drive current value of the electric heating device stable and not higher than the predetermined current value I_{predetermined}, it can be firstly ensured that the drive current of the electric heating device does not exceed the upper limit in order to prevent the drive current from being violated when the power battery pack or the vehicle-mounted charger is electrically connected with the electric heating device and supplies power, so that on one hand, the system safety is ensured, and on the other hand, it can be ensured that the power battery pack or the vehicle-mounted charger is in a good working state to prevent problems of over-current protection and the like. It can be designed to select different current values for the predetermined current value I_{predetermined} according to different working conditions, e.g., the current value may be an integer multiple of n, wherein n is the number of the resistance heating units, and the integer multiple may be a single digit or two digits, such as 20.

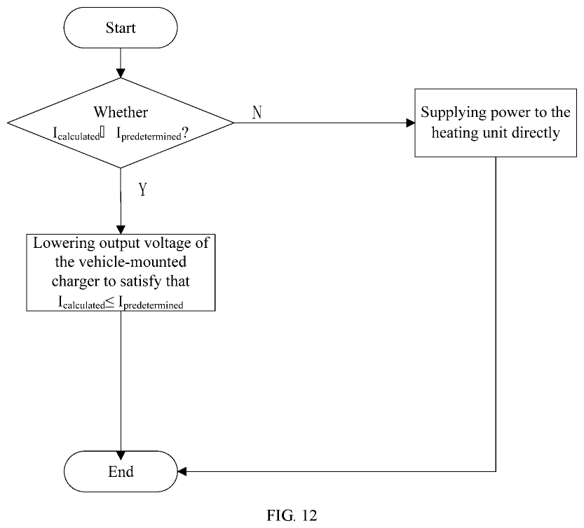

In order to implement the above solution, preferably, the controller includes: a voltage detection module, used for detecting an output voltage of the vehicle-mounted charger and/or the power battery pack; a voltage regulation module, used for regulating the output voltage of the vehicle-mounted charger and/or the power battery pack; and a judging module, used for obtaining a calculated current value I_{calculated} of the electric heating device according to a ratio of the output voltage of the vehicle-mounted charger and/or the power battery pack to the resistance value of the selected resistance heating unit and comparing the calculated current value I_{calculated} with the predetermined current value I_{predetermined}, wherein, as shown in FIG. 12, if the calculated current value I_{calculated} is greater than or equal to the predetermined current value I_{predetermined}, the controller lowers the output voltage of the vehicle-mounted charger and/or the power battery pack until the calculated current value I_{calculated} is not greater than the predetermined current value I_{predetermined}; and if the calculated current value I_{calculated} is smaller than the predetermined current value I_{predetermined}, power is directly supplied to the resistance heating unit to enable the resistance heating unit to perform heating working. In this way, it can be ensured that the drive current of the electric heating device does not exceed the current limiting requirement, thereby ensuring the safety and stability of the system.

The above current limiting solution may apply to the solution of multiple parallel resistors of the electric heating device shown in FIGS. 1 to 4. The following will specifically take two resistors R1 and R2 for example.

Preferably, the electric heating device includes a first resistance heating unit R1 having a greater resistance value and a second resistance heating unit R2 having a smaller resistance value. In this case, the judging module respectively obtains corresponding I_{calculated 1} and I_{calculated 2} for the two resistance heating units, wherein,
if I_{calculated 1} is greater than I_{predetermined}, the controller lowers the output voltage of the vehicle-mounted charger and/or the power battery pack;
if I_{calculated 2} is greater than I_{predetermined} and I_{calculated 1} is smaller than I_{predetermined}, the controller turns on the first resistance heating unit R1 and turns off the second resistance heating unit R2; and
if calculated 2 is smaller than I_{predetermined}, the controller turns on the first resistance heating unit R1 and turns off the second resistance heating unit R2; or the controller turns on the second resistance heating unit R2 and turns off the first resistance heating unit R1; or the controller alternately turns on the first resistance heating unit R1 and the second resistance heating unit R2; or the controller raises the output voltage of the vehicle-mounted charger and/or the power battery pack to a range that satisfy “I_{calculated 2} is greater than I_{predetermined} and I_{calculated 1} is smaller than I_{predetermined}” and then turns on the first resistance heating unit R1 and turns off the second resistance heating unit R2.

In summary, for a plurality of resistance heating units connected in parallel, since the voltages applied to all the resistance heating units are the same, the current of each of the resistance heating units under the voltage can be calculated first and then compared with the predetermined current I_{predetermined}, thus corresponding processing is performed according to comparison results. Although the above solution is described by taking two resistors for example, it should be understood by those skilled in the art that the above solution also similarly applies to the case of more resistors, and the essential spirit of the solution is the same or similar.

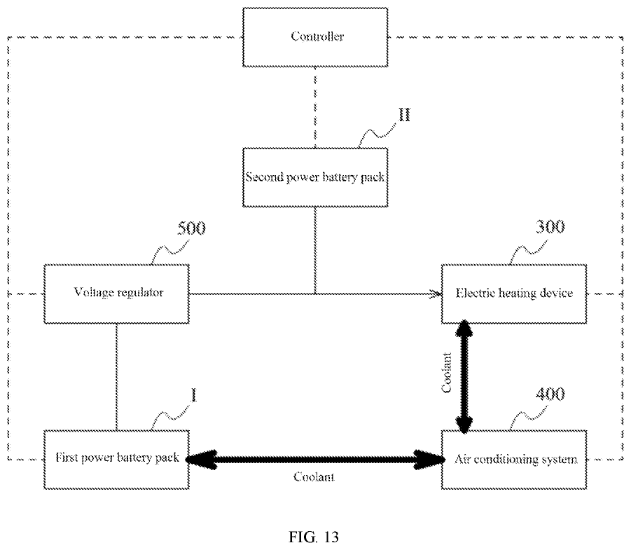

In addition, the present application provides a control system of an electric vehicle according to another embodiment. For example, as shown in FIG. 13, the control system of an electric vehicle includes: a battery management system, used for monitoring and managing operation of a first power battery pack I and a second power battery pack II of the electric vehicle, wherein the first power battery pack I is a fuel cell stack or a rechargeable battery pack, and the second power battery pack II is a rechargeable battery and electrically connected with the first power battery pack I; an electric heating device 300, electrically connected with the first power battery pack I and the second power battery pack II of the electric vehicle respectively; and an air conditioning system 400, used for exchanging heat with the electric heating device 300 through a heat transfer medium for heating the environment in the electric vehicle during working, wherein the heat transfer medium is also used for controlling temperature of the first power battery pack I and/or the second power battery pack II, wherein the electric heating device is the above electric heating device provided by the present application, and the controller is a controller of the electric vehicle and/or a dedicated controller for the electric heating device.

Different from the previous embodiment, in the embodiment illustrated by FIG. 13, there are two power battery packs: the first power battery pack I and the second power battery pack II, wherein the first power battery pack I may be a fuel cell stack or a rechargeable battery pack (such as a lithium ion battery, a nickel-metal hydride battery and a storage battery), and the second power battery pack II may be a rechargeable battery (such as a lithium ion battery, a nickel-metal hydride battery and a storage battery). In this embodiment, by arranging two power battery packs, when one of the power battery packs is started up and starts to work, the other power battery pack can act as supplementary power, thereby facilitating stable starting of the power battery pack, especially during fuel cell stack or low-temperature starting. Therefore, when the electric heating device 300 is combined, the electric heating device 300 may be used for providing the heated heat transfer medium to the first power battery pack I and/or the second power battery pack II, so as to control the temperature of the first power battery pack I and the second power battery pack II to facilitate steady-state working of the power battery packs.

The electric vehicle has at least one of the following working conditions: a normal warm air working condition, wherein the power battery pack is in a normal working state and provides electric energy to the electric heating device 300 that converts the electric energy into heat energy and supplies the heated heat transfer medium to the air conditioning system; and a low-temperature starting working condition, wherein when the temperature of the power battery pack is lower than a lower fifth temperature threshold value (the fifth temperature threshold value is, e.g., −40° C. to −10° C.) and the electric vehicle receives a power-on command, the electric heating device receives electric energy from the first power battery pack and/or the second power battery pack and converts the electric energy into heat energy to supply the heated heat transfer medium to the first power battery pack and/or the second power battery pack, and until the temperature of the first power battery pack and/or the second power battery pack is higher than a higher sixth temperature threshold value (the sixth temperature threshold value is, e.g., −20° C. to 5° C.), the electric vehicle enters the normal warm air working condition. It should be noted, however, that the above-mentioned working conditions of the electric vehicle are divided based on the matching relationship between the electric heating device and the related electrical devices, and do not limit the present application, nor exclude that the working conditions of the electric vehicle are divided into other different working conditions based on other criteria. For example, the working conditions described in the previous embodiment of the control system of an electric vehicle may also be provided.

Under the normal warm air working condition, the vehicle is in a normal operating state, and as described above, PWM control can be performed on the switches Q1, . . . , Qn by the PWM control mode. That is, the PWM control module of the electric heating device sends a control signal to the selected switch so as to continuously regulate and control the power of the electric heating device.

Under the low-temperature starting working condition, according to the technical solution of the present application, the power of the electric heating device is responsive to the power of the first power battery pack and/or the second power battery pack that supplies power to the electric heating device, and is positively correlated with the output voltage of the first power battery pack and/or the second power battery pack that supplies power to the electric heating device without adopting the PWM control mode. Setting is made in such a way because particularly, under the low-temperature starting working condition, the working state of the power battery pack (particularly in the case of a fuel cell stack) is poor when the power battery pack is just started, and the power battery pack can only be at the level of low power output and needs to take a long time for regulation to enable the output power to reach the full power level, and thus quick change of the power requirement of a vehicle cannot be met. In the technical solution of the present application, in addition to using the other power battery pack for supplying the supplementary electric energy, the electric heating device is controlled without adopting the PWM control mode but be provided with a stable load, so that the power of the electric heating device is responsive to the power of the first power battery pack and/or the second power battery pack that supplies power to the electric heating device and is regulated by the regulation of the output voltage of the first power battery pack and/or the second power battery pack that supplies power to the electric heating device. Therefore, in the process of low-temperature starting, the electric heating device is used as a load with a stable resistance value to start heating working, and meanwhile, the power of the electric heating device is directly and positively correlated with the output voltage of the power battery pack, so that the temperature of the power battery pack gradually rises and the output power of the power battery pack gradually increases as the electric heating device provides the heated heat transfer medium to the power battery pack, and then the power of the electric heating device is correspondingly and gradually increased, so that the purpose of quick starting of the power battery pack is achieved. Moreover, in the process of quick starting of the power battery pack, the current can be limited (as described above), and power conflict between the electric heating device and the power battery pack can be avoided so as to avoid starting failure. It should be noted that the control method of this embodiment and the control method of the above embodiment may be combined with each other by referring to each other.

In addition, in the technical solution of the present application, as described above, the controller may be a vehicle-mounted controller such as an ECU, a BMS, and an air conditioner controller, or may be a separate controller of the electric heating device, such as a single chip microcomputer or an integrated chip. Accordingly, the controller should be understood broadly and is meant to cover a variety of individual, combined, integrated, borrowed control units having logic judgment and/or operation functions.

Various embodiments of the control system of an electric vehicle of the present application have been described above in detail.

3. Electric Vehicle

The technical solution of the present application may be used for various working condition applications, e.g., various transport vehicles, in particular electric vehicles. The electric vehicle provided by the present application includes the control system of an electric vehicle, and the electric vehicle is a pure or battery electric vehicle, a fuel cell vehicle or a hybrid electric vehicle.

The preferred embodiments of the present application have been described in detail above. However, the present application is not limited to the specific details of the above embodiments, and various simple modifications can be made to the technical solutions of the present application within the scope of the technical concepts of the present application, and these simple modifications all belong to the protection scope of the present application.

It should be noted that, in the foregoing embodiments, various specific technical features described in the above embodiments may be combined in any suitable mode in the case of non-conflicting. In order to avoid unnecessary repetition, various possible combination modes are not separately described in the present application.

In addition, any combination of the various embodiments of the present application can be made as long as it does not violate the thought of the present application, and shall be regarded as the disclosure of the present disclosure.

1-20. (canceled)

21. An electric heating device of an electric vehicle, wherein the electric heating device comprises:
n resistance heating units (R1, R2, . . . , Rn), electrically connected in parallel with each other independently;
n switches (Q1, Q2, . . . , Qn), electrically connected in series with respective resistance heating units for independently controlling power-on or power-off of the respective resistance heating units; and
a controller, configured to selectively turn on or turn off any at least one of the n switches according to a working condition of the electric vehicle, wherein n is a natural number greater than or equal to 2;
the n switches are all electronic switching tubes, and the controller comprises a PWM control module independently electrically connected with the n switches respectively, the PWM control module has a power error compensation function, wherein, for one switch and one resistance heating unit corresponding thereto,
under the condition that the resistance value of the resistance heating unit is within an intermediate interval of an acceptable error range of a standard resistance value, the PWM control module outputs a control signal with a corresponding standard duty ratio at a predetermined power;
under the condition that the resistance value of the resistance heating unit is within an upper limit interval of the acceptable error range of the standard resistance value, the PWM control module outputs a control signal with a duty ratio greater than the standard duty ratio to the switch at the predetermined power; and
under the condition that the resistance value of the resistance heating unit is within a lower limit interval of the acceptable error range of the standard resistance value, the PWM control module outputs a control signal with a duty ratio smaller than the standard duty ratio to the switch at the predetermined power.

22. The electric heating device of an electric vehicle according to claim 21, wherein the resistance values of the n resistance heating units are all the same, or are all different, or are partially the same and partially different.

23. The electric heating device of an electric vehicle according to claim 22, wherein n is 2, and the ratio of the resistance value of one resistance heating unit to the resistance value of the other resistance heating unit in two resistance heating units is 1 to 2.5.

24. The electric heating device of an electric vehicle according to claim 21, wherein the electric heating device comprises a first main circuit and/or a second main circuit, the first main circuit and the second main circuit are respectively positioned on two sides of the n resistance heating units and are both electrically connected in series with the parallel circuits of the n resistance heating units, and the first main circuit is provided with a first main switch (Q_{main 1}), and/or the second main circuit is provided with a second main switch (Q_{main 2}).

25. The electric heating device of an electric vehicle according to claim 24, wherein at least one of the first main circuit, the second main circuit and the parallel circuits is provided with a detection point (A, B, C, D) for intermittent or real-time detection of a voltage value and/or a current value at the detection point.

26. The electric heating device of an electric vehicle according to claim 24, wherein, the detection point (A, B, C, D) is arranged at each of the switches (Q1, Q2, . . . , Qn) and the main switches.

27. The electric heating device of an electric vehicle according to claim 21, wherein the electric heating device has the following working modes:
a single-resistance heating mode in which the controller only turns on one selected switch among the n switches to power on the corresponding resistance heating unit among the n resistance heating units;
a full-resistance heating mode in which the controller turns on all of the n switches, thereby powering on all of the n resistance heating units; and
a combined-resistance heating mode in which the controller turns on 2 to n−1 of the n switches and does not turn on the other portion of the n switches, thereby powering on a corresponding portion of the n resistance heating units while not powering on the other portion.

28. The electric heating device of an electric vehicle according to claim 27, wherein,
the controller selects the working mode according to a working condition of the electric vehicle so as to limit the current value or the total current value of the resistance heating unit(s) in the on-state below a predetermined current value under the condition that the electric heating device has predetermined heating power; and/or
the controller selects the working mode according to different requirements for heating power under different working conditions, so that the electric heating device has different heating powers without adopting a PWM control mode for the electric heating device.

29. The electric heating device of an electric vehicle according to claim 21, wherein the working frequency of the switches that are turned on under the control of the PWM control module is 1 Hz to 100 KHz.

30. The electric heating device of an electric vehicle according to claim 29, wherein,
the PWM control module has an alternate control mode in which the PWM control module alternately turns on or turns off a plurality of different switches to alternately power on or power off corresponding resistance heating units; and/or
the duty ratios of control signals sent to the switches by the PWM control module are adjustable.

31. A control system of an electric vehicle, comprising:
a battery management system, configured to monitor and manage operation of a power battery pack of the electric vehicle;
a vehicle-mounted charger, electrically connected with the power battery pack of the electric vehicle;
an electric heating device, electrically connected with the power battery pack of the electric vehicle; and
an air conditioning system, configured to exchange heat with the electric heating device through a heat transfer medium for heating the environment inside the electric vehicle during working, the heat transfer medium being also configured to control temperature of the power battery pack,
wherein the electric heating device is the electric heating device according to claim 1, and the controller is a controller of the electric vehicle and/or a dedicated controller for the electric heating device.

32. The control system of an electric vehicle according to claim 31, wherein the electric vehicle has at least one of the following working conditions:
a normal warm air working condition, wherein the power battery pack is in a normal working state and provides electric energy to the electric heating device that converts the electric energy into heat energy and supplies the heated heat transfer medium to the air conditioning system;
a fast charging working condition, wherein the vehicle-mounted charger is electrically connected with an external charging device, and the electric heating device converts electric energy from the power battery pack and/or the vehicle-mounted charger into heat energy and supplies the heated heat transfer medium to the air conditioning system and/or the power battery pack;
a low-temperature slow charging working condition, wherein when the temperature of the power battery pack is lower than a lower first temperature threshold value and the vehicle-mounted charger is electrically connected with the external charging device, the vehicle-mounted charger is disconnected from the power battery pack, the electric heating device converts electric energy from the vehicle-mounted charger into heat energy and supplies the heated heat transfer medium to the power battery pack, and until the temperature of the power battery pack is higher than a higher second temperature threshold value, the vehicle-mounted charger is electrically connected with the power battery pack to charge the power battery pack;
a normal-temperature slow charging working condition, wherein the electric heating device converts electric energy from the vehicle-mounted charger into heat energy and supplies the heated heat transfer medium to the power battery pack, and the vehicle-mounted charger is electrically connected with the power battery pack to charge the power battery pack; and
a low-temperature starting working condition, wherein when the temperature of the power battery pack is lower than a lower third temperature threshold value and the electric vehicle receives a power-on command, the vehicle-mounted charger is disconnected from the power battery pack, the electric heating device is electrically connected with the power battery pack and used for converting electric energy of the power battery pack into heat energy and supplying the heated heat transfer medium to the power battery pack, and until the temperature of the power battery pack is higher than a higher fourth temperature threshold value, the electric vehicle enters the normal warm air working condition.

33. The control system of an electric vehicle according to claim 32, wherein the PWM control module of the electric heating device sends a control signal to the selected switch to continuously regulate and control power of the electric heating device in at least one of the normal warm air working condition, the fast charging working condition and the normal-temperature slow charging working condition.

34. The control system of an electric vehicle according to claim 32, wherein,
in the low-temperature slow charging working condition, the current value of the electric heating device is maintained stable and is not higher than a predetermined current value I_{predetermined}, and the power of the electric heating device is regulated by regulating an output voltage of the vehicle-mounted charger without adopting a PWM control mode; and/or
in the low-temperature starting working condition, the current value of the electric heating device is maintained stable and is not higher than the predetermined current value I_{predetermined}, and the power of the electric heating device is regulated by regulating the output voltage of the power battery pack without adopting the PWM control mode.

35. The control system of an electric vehicle according to claim 34, wherein the controller comprises:
a voltage detection module, configured to detect the output voltage of the vehicle-mounted charger and/or the power battery pack;
a voltage regulation module, configured to regulate the output voltage of the vehicle-mounted charger and/or the power battery pack; and
a judging module, configured to obtain a calculated current value I_{calculated} of the electric heating device according to the ratio of the output voltage of the vehicle-mounted charger and/or the power battery pack to the resistance value of the selected resistance heating unit and to compare the calculated current value I_{calculated} with the predetermined current value I_{predetermined}, wherein,
under the condition that the calculated current value I_{calculated} is greater than or equal to the predetermined current value I_{predetermined}, the controller lowers the output voltage of the vehicle-mounted charger and/or the power battery pack until the calculated current value I_{calculated} is not greater than the predetermined current value I_{predetermined}, and
under the condition that the calculated current value I_{calculated} is smaller than the predetermined current value I_{predetermined}, the resistance heating unit is powered on.

36. The control system of an electric vehicle according to claim 34, wherein the electric heating device comprises a first resistance heating unit (R1) having a greater resistance value and a second resistance heating unit (R2) having a smaller resistance value, and
the judging module obtains corresponding I_{calculated 1} and I_{calculated 2} for the two resistance heating units respectively, wherein,
under the condition that I_{calculated 1} is greater than I_{predetermined}, the controller lowers the output voltage of the vehicle-mounted charger and/or the power battery pack;
under the condition that I_{calculated 2} is greater than I_{predetermined} and I_{calculated 1} is smaller than I_{predetermined}, the controller turns on the first resistance heating unit (R1) and turns off the second resistance heating unit (R2); and
under the condition that I_{calculated 2} is smaller than I_{predetermined}, the controller turns on the first resistance heating unit (R1) and turns off the second resistance heating unit (R2); or the controller turns on the second resistance heating unit (R2) and turns off the first resistance heating unit (R1); or the controller alternately turns on the first resistance heating unit (R1) and the second resistance heating unit (R2); or the controller raises the output voltage of the vehicle-mounted charger and/or the power battery pack to a range that satisfy “I_{calculated 2} is greater than I_{predetermined} and I_{calculated 1} is smaller than I_{predetermined}” and then turns on the first resistance heating unit (R1) and turns off the second resistance heating unit (R2).

37. A control system of an electric vehicle, comprising:
a battery management system, configured to monitor and manage operation of a first power battery pack (I) and a second power battery pack (II) of the electric vehicle, the first power battery pack (I) being a fuel cell stack or a rechargeable battery pack, and the second power battery pack (II) being a rechargeable battery and electrically connected with the first power battery pack (I);
an electric heating device, electrically connected with the first power battery pack (I) and the second power battery pack (II) of the electric vehicle; and
an air conditioning system, configured to exchange heat with the electric heating device through a heat transfer medium for heating the environment inside the electric vehicle during working, the heat transfer medium being also configured to control temperature of the first power battery pack (I) and/or the second power battery pack (II),
wherein the electric heating device is the electric heating device according to claim 1, and the controller is a controller of the electric vehicle and/or a dedicated controller for the electric heating device.

38. The control system of an electric vehicle according to claim 37, wherein the electric vehicle has at least one of the following working conditions:
a normal warm air working condition, wherein the power battery pack is in a normal working state and provides electric energy to the electric heating device that converts the electric energy into heat energy and supplies the heated heat transfer medium to the air conditioning system; and
a low-temperature starting working condition, wherein when the temperature of the power battery pack is lower than a lower fifth temperature threshold value and the electric vehicle receives a power-on command, the electric heating device receives electric energy from the first power battery pack and/or the second power battery pack and converts the electric energy into heat energy so as to supply the heated heat transfer medium to the first power battery pack and/or the second power battery pack, and until the temperature of the first power battery pack and/or the second power battery pack is higher than a higher sixth temperature threshold value, the electric vehicle enters the normal warm air working condition.

39. The control system of an electric vehicle according to claim 38, wherein in the low-temperature starting working condition, the power of the electric heating device is responsive to the power of the first power battery pack and/or the second power battery pack that supplies power to the electric heating device, and is positively correlated with the output voltage of the first power battery pack and/or the second power battery pack that supplies power to the electric heating device without adopting a PWM control mode.

40. An electric vehicle, comprising the control system of an electric vehicle according to claim 1, wherein the electric vehicle is a pure or battery electric vehicle, a fuel cell vehicle or a hybrid electric vehicle.
